(19) United States
(12) Patent Application Publication
(10) Pub. No.: US 2020/0084835 A1
(43) Pub. Date: Mar. 12, 2020

(54) Control of Remote UE to Access Network via a Relay UE Based on Access Level and Access Restriction Configuration

(71) Applicant: Nokia Solutions and Networks Oy, Espoo (FI)

(72) Inventors: Zhi WANG, Shanghai (CN); Yigang CAI, Naperville, IL (US)

(21) Appl. No.: 16/467,271

(22) PCT Filed: Dec. 20, 2017
(86) PCT No.: PCT/EP2017/083682

§ 371 Date: Jun. 6, 2019

(30) Foreign Application Priority Data
Dec. 20, 2016 (CN) 201611188136.5

(51) Int. Cl. H04W 88/04; H04W 48/16; H04W 76/14; H04W 8/00; H04W 48/02

(52) U.S. Cl. CPC H04W 88/04; H04W 48/16; H04W 48/02; H04W 8/005; H04W 76/14

(57) ABSTRACT

Embodiments of the present disclosure relate to a method and corresponding device for controlling a remote UE to access to a network via a relay UE. The method includes: the remote UE receives, from a proximity service function, an access level configuration message, which contains access level allocated to the remote UE; receiving access restriction configuration information from the relay UE via a PC5 interface; when an application on the remote UE initiates a request for accessing the network, rejecting the request for accessing the network if the access level of the remote UE is matched with the access restriction configuration information. A device capable of implementing the above method is also disclosed.

### TECHNOLOGY

Embodiments of the present disclosure generally relate to communication technology, and more specifically, to a method and a corresponding device for controlling D2D communication.

### BACKGROUND

Device-to-Device (D2D) communication is a new technology for enabling terminals to communicate directly with each other by multiplexing cell resources under the control of the system. It can improve spectrum efficiency of a cellular communication system and reduce transmission power of a terminal, so as to solve the problem of scarce spectrum resources in a wireless communication system to some extent.

At present, there are many researches about D2D, one of which is D2D relay. In this technical solution, a relay UE provides connection to the operator network for a remote UE and relays traffic between the remote UE and the network. In accordance with the definition of 3GPP, the remote UE mentioned herein refers to the UE not being served by Evolved Universal Terrestrial Radio Access Network (E-UTRAN) or UE being connected to the operator network via a relay UE to enjoy network service. The relay UE mentioned here is also referred to as UE-to-Network relay UE.

The current D2D relay scheme does not consider overload control for Radio Access Network (RAN) and core network (CN). When many remote UEs initiate requests for network access through a relay UE, the access network and core network will be overloaded tremendously. Therefore, how to control access of a remote UE effectively in a D2D relay scenario becomes an unavoidable problem.

### SUMMARY

In general, embodiments of the present disclosure propose a method and device for controlling a remote UE to access to the network.

In a first aspect of the present disclosure, there is provided a method in a remote UE for controlling the remote UE to access a network by a remote UE via a relay UE, including: receiving, from a proximity service function, an access level configuration message which contains an access level allocated to the remote UE; receiving access restriction configuration information from the relay UE via a PC5 interface, the access restriction configuration information indicating remote UEs that are unable to access the network via the relay UE; when an application on the remote UE initiates a request for accessing the network, rejecting the request for accessing the network if the access level of the remote UE is matched with the access restriction configuration information.

In some embodiments, the method further includes: obtaining, from the proximity service function, information obtained by applying a certain algorithm to the access level; where receiving the access restriction configuration information from the relay UE via the PC5 interface further includes: receiving, from the relay UE via the PC5 interface, information obtained by applying the algorithm to the access restriction configuration information; where the matching step further includes: when the application on the remote UE initiates the request for accessing the network, rejecting the request for accessing the network if the information obtained by applying the algorithm to the access level of the remote UE is matched with the information obtained by applying the algorithm to the access restriction configuration information.

In some embodiments, the method further includes: receiving, from the proximity service function, an access restriction cancelling message which contains access restriction cancelling information, the access restriction cancelling information indicating a condition for cancelling an access restriction; and when the condition for cancelling the access restriction are met, allowing the remote UE to access the network via the relay UE.

In a second aspect of the present disclosure, there is provided a method in a relay UE for controlling a remote UE to access a network via a relay UE, including: receiving, from an eNB, a D2D access restriction configuration message, which contains access restriction configuration information, the access restriction configuration information indicating the remote UEs that are unable to access the network via the relay UE; and transmitting the access restriction configuration information to the remote UE via a PC5 interface.

In some embodiments, the method further includes: transmitting a discovery request to the proximity service function, the discovery request containing the access restriction configuration information; receiving, from the proximity service function, a discovery response which contains information obtained by applying a certain algorithm to the access restriction configuration information; where the access restriction configuration information transmitted to the remote UE via the PC5 interface further includes: transmitting, to the remote UE via the PC5 interface, information obtained by applying the algorithm to the access restriction configuration information.

In a third aspect of the present disclosure, there is provided a method in a proximity service function for controlling a remote UE to access to a network via a relay UE, comprising: transmitting, to the remote UE, an access level configuration message which contains an access level allocated to the remote UE.

In some embodiments, the method further includes: in response to a discovery request from the relay UE, the discovery request containing access restriction configuration information, transmitting a rely to the discovery request to the relay UE, the discovery response containing the access restriction configuration information, the access restriction configuration information indicating remote UEs that are unable to access the network via the relay UE.

In some embodiments, transmitting the discovery response to the relay UE further comprises: the discovery response containing information obtained by applying a certain algorithm to the access restriction configuration information; the method further comprises: in response to the discovery request from the remote UE, the discovery request containing the access level of the remote UE, transmitting, to the remote UE, a discovery response, which contains information obtained by applying the algorithm to the access level.

In a fourth aspect of the present disclosure, there is provided an apparatus in a remote UE for controlling access to the network by the remote UE via the relay UE, comprising: a first receiving apparatus configured to receive, from a proximity service function, an access level configuration message which contains an access level allocated to the remote UE; a second receiving apparatus configured to receive the access restriction configuration information from the relay UE via a PC5 interface, the access restriction configuration information indicating remote UEs that are unable to access the network via the relay UE; a first access control apparatus configured to, when an application on the remote UE initiates a request for accessing the network, reject the request for accessing the network if the access level of the remote UE is matched with the access restriction configuration information.

In some embodiments, the apparatus further comprises: an obtaining unit configured to obtain, from a proximity service function, information obtained by applying a certain algorithm to the access level; wherein the second receiving unit is further configured to: receive, from the relay UE via the PC5 interface, information obtained by applying the algorithm to the access restriction configuration information; where the first access control unit is further configured to: when an application from the remote UE initiates the request for accessing the network, reject the request for accessing the network if the information obtained by applying the algorithm to the access level of the remote UE is matched with the information obtained by applying the algorithm to the access restriction configuration information.

In some embodiments, the apparatus further comprises: a third receiving unit configured to receive, from the proximity service function, an access restriction cancelling message, which contains the access restriction cancelling information, the access restriction cancelling information indicating a condition for cancelling access restriction; a second access control unit configured to, when the condition for cancelling the access restriction is met, allow the remote UE to access the network via the relay UE.

In a fifth aspect of the present disclosure, there is provided an apparatus in the relay UE for controlling a remote UE to access a network via a relay UE, comprising: a fourth receiving unit configured to receive, from an eNB, D2D access restriction configuration message, which contains an access restriction configuration information, the access restriction configuration information indicating remote UEs that are unable to access the network via the relay UE; a first transmitting unit configured to transmit the access restriction configuration information to the remote UE via a PC5 interface.

In some embodiments, the apparatus further comprises: a second transmitting unit configured to transmit a discovery request to the proximity service function, the discovery request containing the access restriction configuration information; a fifth receiving unit configured to receive, from the proximity service function, a discovery response, which contains information obtained by applying a certain algorithm to the access restriction configuration information; where the first transmitting unit is further configured to: transmit, to the remote UE via the PC5 interface, the information obtained by applying the algorithm to the access restriction configuration information.

In a sixth aspect, there is provided an apparatus in a proximity service function configured to control a remote UE to access to the network via a relay UE, comprising: a third transmitting unit for transmitting to the remote UE, an access level configuration message, which contains the access level of the remote UE.

In some embodiments, the apparatus further comprises: a fourth transmitting unit configured to, in response to the discovery request from the relay UE, which contains access restriction configuration information, transmit a discovery response to the relay UE, the discovery response containing the access restriction configuration information, the access restriction configuration information indicating remote UEs that are unable to access the network via the relay UE.

In some embodiments, the discovery response further contains information obtained by applying a certain algorithm to the access restriction configuration information; the apparatus further comprises: a fifth transmitting unit configured to, in response to the discovery request from the remote UE, the discovery request containing access level of the remote UE, transmit, to the remote UE, a discovery response which contains information obtained by applying the algorithm to the access level.

In the embodiments of the present disclosure, by allocating an access level to the remote UE and configuring access restriction configuration information to the core network or eNB, the access request of the remote UE via the relay UE can be controlled, thereby reducing load to the wireless access network and core network effectively, and controlling D2D relay access flexibly based on various attribute information (such as access priority, application types or UE types and so on) of the remote UE and adjusting the network load dynamically.

It will be appreciated that the Summary does not intend to indicate essential or important features of embodiments of the present disclosure or to limit the scope of the present disclosure. Other features of the present disclosure will be more comprehensible with the following depiction.

### BRIEF DESCRIPTION OF THE DRAWINGS

Through the following detailed description with reference to the accompanying drawings, the above and other features, advantages, and aspects of embodiments of the present disclosure will become more apparent. In the drawings, identical or similar reference numbers represent the same or similar elements.

FIG. 1 illustrates an example network architecture in which an embodiment of the present disclosure can be implemented;

FIG. 2 is a flowchart illustrating a method for controlling a remote UE to access the network via a relay UE according to an embodiment of the present disclosure;

FIG. 3(a) is a schematic diagram illustrating a process for controlling a remote UE to access the network via a relay UE according to an embodiment of the present disclosure;

FIG. 3(b) is a schematic diagram illustrating a process for controlling a remote UE to access the network via a relay UE according to another embodiment of the present disclosure;

FIG. 4 is a schematic diagram illustrating a process for controlling a remote UE to access the network via a relay UE according to another embodiment of the present disclosure;

FIG. 5(a) is a schematic diagram illustrating a process for controlling a remote UE to access the network via a relay UE according to another embodiment of the present disclosure;

FIG. 5(b) is a schematic diagram illustrating a process for controlling a remote UE to access the network via a relay UE according to another embodiment of the present disclosure;

FIG. 5(c) is a schematic diagram illustrating a process for controlling a remote UE to access the network via a relay UE according to another embodiment of the present disclosure;

FIG. 6 is a block diagram illustrating an apparatus in a remote UE for controlling the remote UE to access the network via a relay UE according to the embodiments of the present disclosure;

FIG. 7 is a block diagram illustrating an apparatus in a relay UE for controlling a remote UE to access the network via a relay UE according to the embodiments of the present disclosure;

FIG. 8 is a block diagram illustrating an apparatus in a proximity service function for controlling a remote UE to access the network via a relay UE.

Through the drawings, identical or similar reference numbers represent the same or similar elements.

### DETAILED DESCRIPTION

Embodiments of the present disclosure will be described with reference to the drawings in detail. Though some embodiments of the present disclosure are shown in the drawings, it should be appreciated that the present disclosure can be implemented in various manners and should not be interpreted as limited to the embodiments described herein. Conversely, these embodiments are provided for thorough and complete understanding of the present disclosure. It is to be understood that the drawings and embodiments of the present disclosure are only for illustrative purposes, rather than to limit the scope of protection of present disclosure.

As used herein, the terms “terminal device” or “user equipment (UE)” may include various information sensing devices (also called IoT devices), such as a radio frequency identifying device, an infrared sensors, a global positioning system, a laser scanner and so on. “Terminal device” or “user equipment” (UE) may further include any terminal device that can perform wireless communication with a base station or with each other, such as a mobile terminal (MT), a subscriber station (SS), a portable subscriber station (PSS), a mobile station (MS), or an access terminal (AT), the above devices mounted on a vehicle, a MTC device and the like. In the context of the present disclosure, for the sake of convenience, terms “terminal device” and “user equipment” can be used interchangeably.

As used herein, the term “includes” and its variants are to be read as open-ended terms that mean “includes, but is not limited to.” The term “based on” is to be read as “based at least in part on.” The term “one example embodiment” is to be read as “at least one example embodiment” and the term “another embodiment” represents “at least one another embodiment.” The definition of other terms will be given in the following context.

As stated above, current D2D relay schemes might cause overload of the wireless access network and core network. To at least partially solve the above and other potential problems, embodiments of the present disclosure provide a method for controlling a remote UE to access the network via a relay UE.

The present disclosure will be described in greater detail with reference to the drawings.

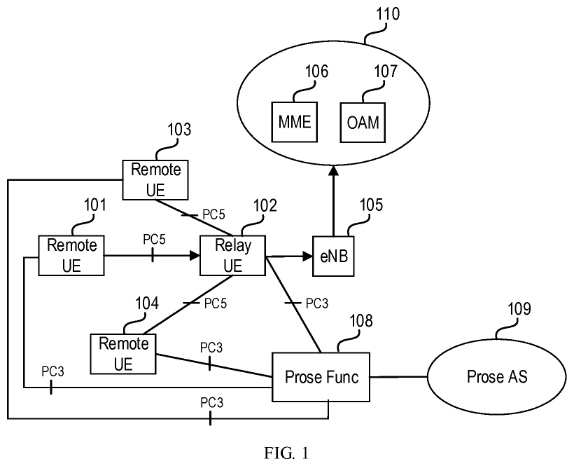

FIG. 1 illustrates an example network architecture in which an embodiment of the present disclosure can be implemented. In this embodiment, a remote UE101, a remote UE 103, and a remote UE104 may establish D2D communication with a relay UE102 via a PC5 interface and access the network via a relay UE102. The relay UE102 may access the core network 110 via an evolved Node B (eNB) 105, the core network 110 including a network element Mobility Management Entity (MME) 106 and Operation Administration and Maintenance (OAM) 107 and so on. The remote UE101, remote UE103, remote UE104, and relay UE102 communicate with Proximity Service Function (Prose Func) 108 via a PC3 interface and Prose Func108 is connected with Proximity Service Application Server (Prose AS) 109.

It should be understood that the type and number of devices and/or elements shown in FIG. 1 is only for illustrative purpose, rather than for limiting. The network architecture generally may also include devices such as a network gate, which are not shown in FIG. 1 for the purpose of simplification.

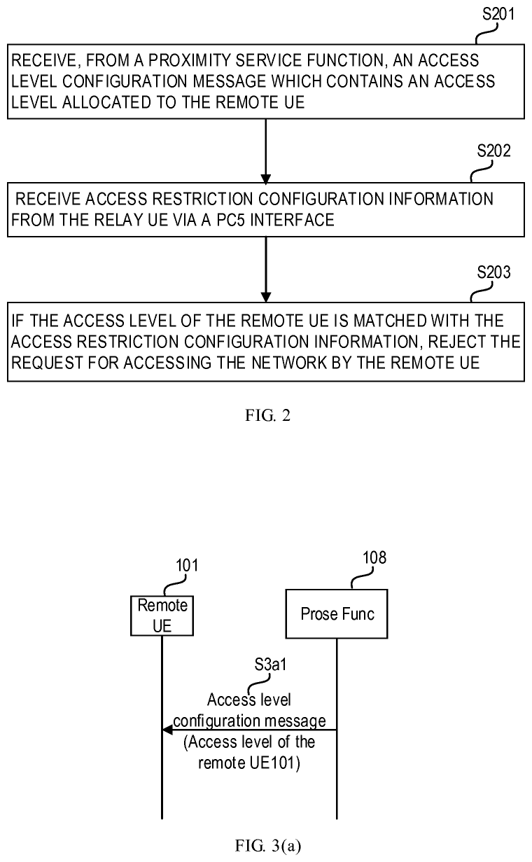

FIG. 2 is a flowchart illustrating a method for controlling a remote UE to access the network via a relay UE according to an embodiment of the present disclosure. It may be appreciated that the method may be implemented at the remote UE (such as remote UE101, remote UE103, and remote UE104). For the ease of depiction, the method is illustrated below with reference to FIG. 1.

First of all, at step S201, the remote UE101 receives, from Prose Func108, an access level configuration message, which contains an access level allocated to the remote UE101.

The access level is allocated by a D2D server (for instance, Prose Func 108 or Prose AS 109). The access level contains associated information for determining whether to allow the remote UE101 to access the network by means of D2D. In some embodiments, the access level contains at least one of the following:
access priority of the remote UE101 indicating the priority of D2D communication corresponding to the remote UE101. The higher the priority is, D2D communication corresponding to the remote UE101 will be considered with greater priority. In determining the access priority the following factors may be taken into account: application priority, user priority, geographical position of UE, time and so on. For example, the priority of a public security application is higher than a social network application.
application type indicating types of applications for D2D communication. These types may be social network applications, public service applications (such as water, power, and gas applications), emergency service applications, commercial applications, and so on.
UE type. UEs may be categorized based on strength of UE signals or processing capacity of UE, for instance.

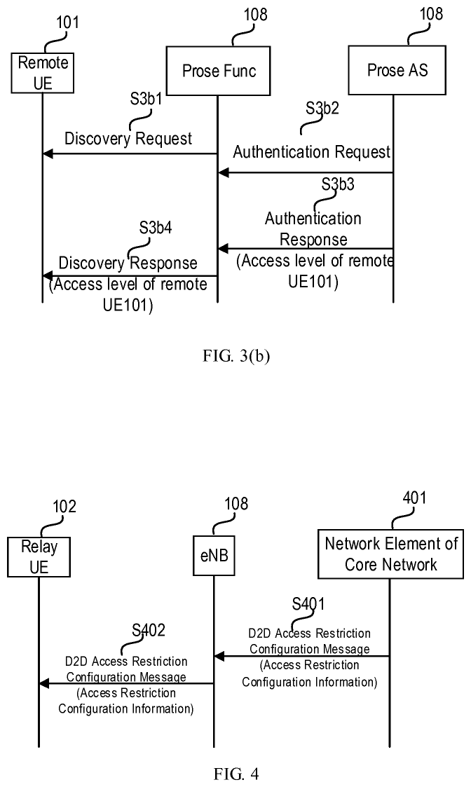

In some embodiments, the access level configuration message is a message newly introduced by the present disclosure. In some other embodiments, the access level configuration message is an existing message in a current standard. Step S201 will be described below in detail with reference to FIGS. 3(a) and 3(b).

Then, at step S202, the remote UE101 receives access restriction configuration information from the relay UE102 via a PC5 interface. The access restriction configuration information indicates remote UEs that cannot access the network via the relay UE102. The access restriction configuration information is set by a network element (such as MME106 or OAM107) of the core network or eNB105 and transmitted to the relay UE102. In some embodiments, the access restriction configuration information includes at least one of the following:
access priority of remote UE. The access restriction configuration information indicates that remote UEs with an access priority of a set value cannot access the network via the relay UE102.
application type. The access restriction configuration information indicates that remote UEs with a set application type cannot access the network via the relay UE102. These types may be a social network application, a public service application (such as water, power, and gas applications), an emergency service application, a commercial application, and so on.
UE type. The access restriction configuration information indicates that the remote UE with a set UE type cannot access the network via the relay UE102.

In some embodiments, the access restriction configuration information further contains a validity period, and the access restriction configuration information is only valid during this validity period.

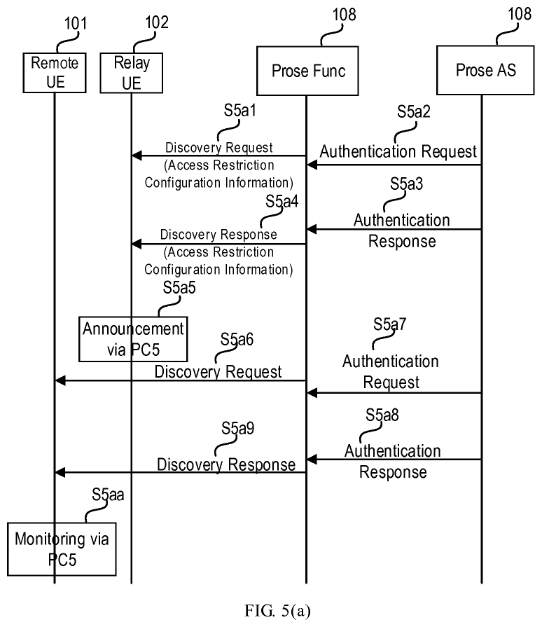

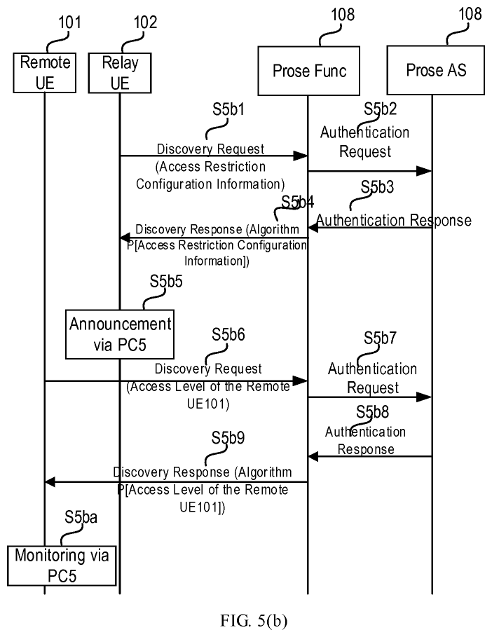

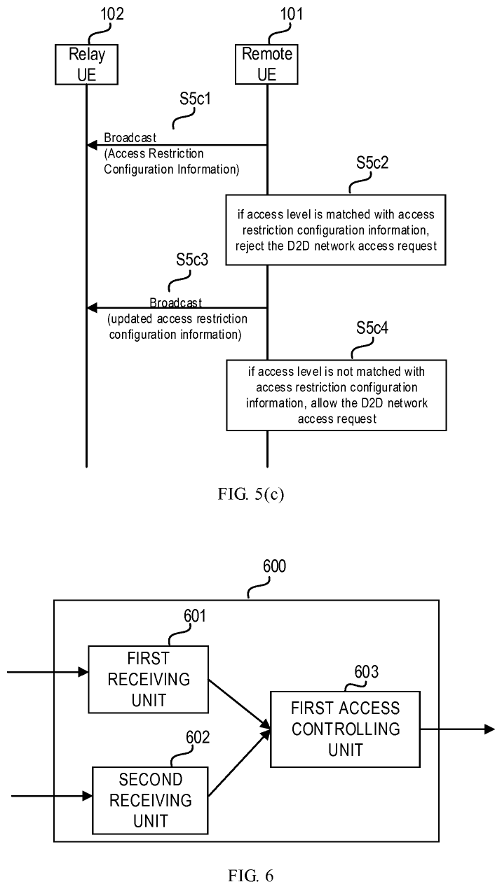

Step S202 will be described below in detail with reference to FIGS. 4, 5(a), 5(b), and 5(c).

At step S203, when an application on the remote UE101 initiates a D2D communication request (namely, accessing the network through the UE102 as an agent), if the access level of the remote UE101 is matched with the access restriction configuration information, the remote UE101 will reject the request for accessing the network. That is, in accordance with the above access restriction configuration information, if the remote UE101 belongs to remote UEs that cannot access the network via the relay UE102, then the remote UE101 cannot create a D2D connection with relay UE102 and cannot access the network via the relay UE102.

In embodiments of the present disclosure, by allocating an access level to the remote UE and configuring access restriction configuration information, the access request of the remote UE via a relay UE can be controlled, thereby reducing load of the wireless access network and the core network effectively.

In some other embodiments, to ensure security of information transfer, it is possible to transform the above access level and the above access restriction configuration information through a certain algorithm. The above method further includes the following step (not illustrated in the figure): obtaining information from Prose Func108 obtained by applying a certain algorithm to the access level of the remote UE101.

The above step S202 further includes: the remote UE101 receives, via a PC5 interface, information from the relay UE102 obtained by applying the algorithm to the above access restriction configuration information.

The above step S203 further includes: when an application on the remote UE101 initiates a D2D connection request (namely, accessing the network through UE102 as an agent). If the information obtained by applying a certain algorithm to the access level of the remote UE101 is matched with the information obtained by applying the algorithm to the above access restriction configuration information, the remote UE101 will reject the request for accessing the network.

In some other embodiments, the above method may further include the following step (not illustrated in the figure): the remote UE101 receives, from the Prose Func108, the access restriction cancelling message, which contains the access restriction cancelling information. The access restriction cancelling information indicates conditions for cancelling access restriction. When the conditions for cancelling the access restriction are met, the remote UE101 is allowed to access the network via the relay UE. In some embodiments, the access restriction cancelling information includes at least one of the following:
time. When the time for the remote UE101 to initiate D2D connection request is within the set time, the remote UE101 will neglect the above access restriction configuration information, establish D2D communication with the relay UE102, and access the network via the relay UE102.
location. When the location for the remote UE101 to initiate D2D connection request is within the set location, the remote UE101 will neglect the above access restriction configuration information, establish D2D communication with the relay UE102, and access the network via the relay UE102.
application type. When the application type for the remote UE101 to initiate D2D connection request is a set one (such as an emergency service application), the remote UE101 will neglect the above access restriction configuration information, establish D2D communication with the relay UE102, and access the network via the relay UE102.

FIG. 3(a) is a schematic diagram illustrating a procedure for controlling a remote UE to access to the network via a relay UE according to an embodiment of the present disclosure. The procedure illustrates a process for allocating the access level to the remote UE101.

At step S3al, Prose Func108 transmits, to the remote UE101, an access level configuration message, which contains an access level allocated by the Prose Func108 to the remote UE101. The access level configuration message in the embodiments of the present disclosure is a newly introduced message. The access level allocated by Prose Func108 to the remote UE101 contains the following information:

the access priority of the remote UE101 is 6 (access priority from 0-9);

application type: a social network application;

UE type: type 1 (based on the processing capability of UE, there are three UE types in total).

FIG. 3(b) is a schematic diagram illustrating a procedure for controlling a remote UE to access the network via a relay UE according to another embodiment of the present disclosure. The procedure illustrates a process for allocating an access level to the remote UE101. The process is based on and makes improvement to the Prose Direct Discovery process of 3GPP standard 23.303.

At step S3b1, the remote UE101 transmits a discovery request to Prose Func108.

At step S3b2, Prose Func108 transmits an authentication request to the Prose AS109.

At step S3b3, Prose AS109 transmits, to the Prose Func108, an authentication response which contains an access level allocated by Prose AS109 to the remote UE101.

At step S3b4, the discovery response is transmitted. The discovery response contains an access level allocated by Prose AS109 to the remote UE101.

In this embodiment, the access level transmitted by Prose AS109 to the remote UE101 contains the following information:

the access priority of the remote UE101 is 6 (access priority from 0-9);

application type: a social network application:

UE type: type 1 (based on the processing capability of UE, there are three UE types in total).

FIG. 4 is a schematic diagram illustrating a procedure for controlling a remote UE to access the network via a relay UE according to another embodiment of the present disclosure. This procedure illustrates a process for setting access restriction configuration information.

At step S401, when the network element 401 of the core network detects network congestion or overload, D2D access restriction configuration information, which contains access restriction configuration information, is transmitted to eNB108. The network element 401 of the core network may be MME106 or OAM107. The D2D access restriction configuration message is a message newly introduced by the present invention. The access restriction configuration information indicates remote UEs that cannot access the network via the relay UE102. In this embodiment, the access restriction configuration information includes the following information:

a remote UE with the priority level of 0-6 cannot access the network;

a remote UE with the application type as a social network application or a commercial application cannot access the network;

a remote UE with the UE type as type 2 or type 3 cannot access the network.

At step S402, eNB108 transmits the received access restriction configuration information to the relay UE102. As illustrated in the figure, eNB108 transmits, to the relay 102, a D2D access restriction configuration message, which contains the above access restriction configuration information.

FIG. 5(a) is a schematic diagram illustrating a process for controlling a remote UE to access the network via a relay UE according to another embodiment of the present disclosure. This process illustrates a procedure for the relay UE102 to transmit the access restriction configuration information to the remote UE101. The process is based on and makes improvement to the Prose Direct Discovery process of 3GPP standard 23.303 with the relay UE102 acting as an announcing UE, and the remote UE101 acting as a monitoring UE.

Steps S5a1 to S5a5 illustrate the announcing process of the relay UE102. At step S5a1, the discovery request transmitted by the relay UE102 to the Prose Func 108 is added with access restriction configuration information. At step S5a5, the content announced by the relay UE102 via PC5 interface contains the above access restriction configuration information.

Steps 5a6 to 5aa illustrate a monitoring process of the remote UE101. At step S5aa, the remote UE101 receives the above access restriction configuration information from the relay UE102 via the PC5 interface.

Then, the remote UE101 will compare its own access level with the above received access restriction configuration information. If the access level of the remote UE101 is matched with the above received access restriction configuration information, the remote UE101 will reject establishment of D2D communication via the relay UE102, namely, reject its access to the network via the relay UE102.

In this embodiment, the access level of the remote UE101 contains the following information:

the access priority of the remote UE101 is 6 (access priority from 0-9);

application type: a social network application:

UE type: type 1 (based on the processing capability of UE, there are three UE types in total).

In this embodiment, the access restriction configuration information contains the following information:

a remote UE with the priority level of 0-6 cannot access the network;

a remote UE with the application type as a social network application or a commercial application cannot access the network;

a remote UE with the UE type as type 2 or type 3 cannot access the network.

In this embodiment, the access level of the remote UE101 is matched with the received access restriction configuration information. Therefore, the remote UE101 will reject its request for accessing the network via the relay UE102 until one of the following conditions is effected:

1) the validity period of the above access restriction configuration information has expired;

2) new access restriction configuration information is received, and the access level of the remote UE101 is not matched with the new access restriction configuration information;

3) access restriction cancelling information is received, and conditions for cancelling access restriction are met.

FIG. 5(b) is a schematic diagram illustrating a process for controlling a remote UE to access the network via a relay UE according to another embodiment of the present disclosure. The process illustrates a procedure for the relay UE102 to transmit access restriction configuration information to the remote UE101. The process is based on and makes improvement to the ProSe Direct Discovery process of 3GPP standard 23.303 with the relay UE102 acting as an announcing UE, and the remote UE101 acting as a monitoring UE.

Steps S5b1 to S5b5 illustrate the announcing process of the relay UE102. At step S5b1, the discovery request transmitted by the relay UE102 to Prose Func 108 is added with access restriction configuration information. The Prose Func 108 will transform the access restriction configuration information with an algorithm P. At step S5b4, the discovery response transmitted by the Prose Func 108 to the relay UE102 contains the above transformed information: the algorithm P[access restriction configuration information]. Then, at step S5a5, the content announced by the relay UE102 via the PC5 interface contains the above transformed information: algorithm P[access restriction configuration information].

Steps S5b6 to S5ba illustrate the monitoring process of the remote UE101. At step S5b6, the discovery request transmitted by the remote UE101 to the Prose Func 108 is added with the access level of the remote UE101. Prose Func 108 will transform the access level with the algorithm P. At step S5b9, the discovery response transmitted by the Prose Func 108 to the remote UE101 will contain the above transformed information: the algorithm P[access level of the remote UE101]. Then, at step S5ba, information from the relay UE102 is received by the remote UE101 via the PC5 interface: algorithm P[access restriction configuration information].

Thereafter, the remote UE101 will compare the algorithm P[access level of the remote UE101] with the received algorithm P[access restriction configuration information]. If the two are matched, the remote UE101 will reject establishing D2D communication with the relay UE102, namely, reject its access to the network via the relay UE102 until one of the following conditions is effected:

1) the validity period of the above access restriction configuration information has expired;

2) new access restriction configuration information is received, and the access level of the remote UE101 is not matched with the new access restriction configuration information;

3) access restriction cancelling information is received, and the conditions for cancelling access restriction are met.

FIG. 5(c) is a schematic diagram illustrating a process for controlling a remote UE to access the network via a relay UE according to another embodiment of the present disclosure.

The process illustrates the procedure for the remote relay UE102 to transmit the access restriction configuration information to the remote UE101. The process is based on and makes improvement to the ProSe Direct Discovery of 3GPP standard 23.303.

At step S5c1, the relay UE102 broadcasts the access restriction configuration information via the PC5 interface. The remote UE101 receives the access restriction configuration information via the PC5 interface.

At step S5c2, the remote UE101 compares its own access level with the above access restriction configuration information. If the two are matched, the remote UE101 rejects its establishment of D2D communication via the relay UE102, namely, reject the request for accessing the network by the remote UE101 via the relay UE102.

At step S5c3, the relay UE102 broadcasts the updated access restriction configuration information via the PC5 interface. The remote UE101 receives the updated access restriction configuration information via the PC5 interface.

At step S5c4, the remote UE101 compares its own access level with the above updated access restriction configuration information. If the two are not matched, the remote UE101 allows establishment of D2D communication via the relay UE102, namely, allow the request for accessing the network by the remote UE101 via the relay UE102.

FIG. 6 is a block diagram illustrating an apparatus in a remote UE for controlling a remote UE to access the network via a relay UE according to the embodiments of the present disclosure. The apparatus 600 may be implemented as the remote UE101, remote UE103, and remote UE104 illustrated in FIG. 1, comprising: a first receiving unit 601, a second receiving unit 602 and a first access controlling unit 603.

The working process of the apparatus 600 will be described below in detail with reference to FIGS. 1 to 5.

First of all, the first receiving unit 610 receives the access level configuration information from the Prose Func 108, which contains the access level allocated to the remote UE101. The access level configuration message and access level have been described above in detail, thus omitted here.

Then, the second receiving unit 602 receives the access restriction configuration information from the relay UE102 via the PC5 interface. The access restriction configuration information indicates remote UEs that cannot access the network via the relay UE102. The access restriction configuration information is set by a network element (such as MME106 or OAM107) of the core network or eNB105 and transmitted to the relay UE102. The access restriction configuration information has been described above in detail, thus omitted here.

The first access controlling unit 603 is used for the following: when an application on the remote UE101 initiates a D2D connection request (namely, accessing the network through the UE102 as an agent), if the access level of the remote UE101 is matched with the above access restriction configuration information, the first access controlling apparatus 603 would reject the request for accessing the network. That is, based on the above access restriction configuration information, if the remote UE101 belongs to remote UEs that cannot access the network via the relay UE102, the remote UE101 cannot establish a D2D connection with the relay UE102 and cannot access the network via the relay UE102.

In some other embodiments, to ensure security of information transfer, it is possible to transform the above access level and the above access restriction configuration information through a certain algorithm. The apparatus 600 further includes an obtaining apparatus (not shown in the figure) for obtaining, from Prose Func 108, information obtained by applying a certain algorithm to the access level of the remote UE101.

The second receiving unit 602 is further used for the following: the remote UE101 receives, via the PC5 interface, information from the relay UE102 obtained by applying the algorithm to the above access restriction configuration information.

The first access controlling unit 603 is further used for the following: when an application on the remote UE101 initiates a D2D connection request (namely, to access the network through UE102 as an agent), if the above information obtained by applying a certain algorithm to the access level of the remote UE101 is matched with the information obtained by applying the algorithm to the above access restriction configuration information, the first access controlling unit 603 will reject the request for accessing the network.

In some other embodiments, the above method further comprises a third receiving apparatus (not shown in the figure) and a second access controlling apparatus (not shown in the figure). The third receiving apparatus receives, from the Prose Func 108, the access restriction cancelling message, which contains the access restriction cancelling information. The access restriction cancelling information indicates conditions for cancelling access restriction. The second access controlling apparatus is used for the following: when the conditions for cancelling the access restriction are met, the remote UE101 is allowed to access the network via the relay UE. The access restriction cancelling information has been described above in detail, which will not be repeated here.

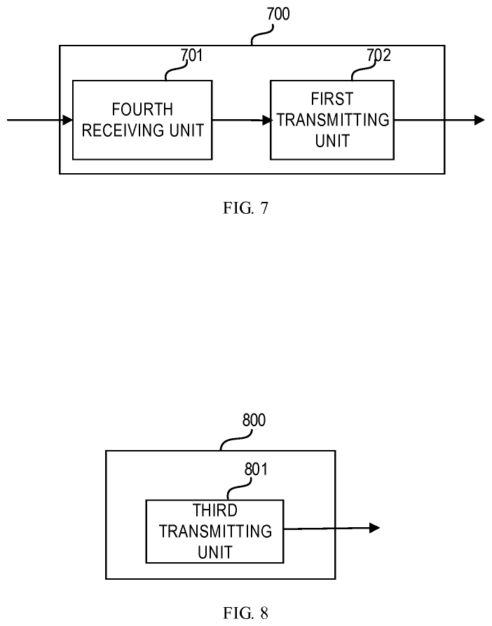

FIG. 7 is a block diagram illustrating an apparatus in a relay UE for controlling a remote UE to access the network via a relay UE according to the embodiments of the present disclosure. The apparatus 700 may be implemented as the relay UE102 shown in FIG. 1, comprising: a fourth receiving unit 701 and a first transmitting unit 702.

The working process of the apparatus 700 will be described below in detail with reference to FIGS. 1-5.

First of all, the fourth receiving unit 710 receives, from eNB, the D2D access restriction cancelling message, which contains the access restriction configuration information. The access restriction configuration information indicates remote UEs that cannot access the network via the relay UE102. The access restriction configuration information is set by the network element (such as MME106 or OAM10) of the core network or eNB105. The access restriction configuration information has been described above in detail, which will not be repeated here.

Then, the first transmitting unit 701 transmits the access restriction configuration information to the remote UE101 via a PC5 interface. In some embodiments, the relay UE102 transmits the access restriction configuration information to the remote UE101 based on the proximity service direct discovery process of the 3GPP standard 23.303. In some embodiments, the relay UE102 transmits the access restriction configuration information to the remote UE101 based on the proximity service direct communication process of the 3GPP standard 23.303.

In some other embodiments, to ensure security of information transfer, the apparatus 700 further includes a second transmitting apparatus (not shown in the figure) and a fifth receiving apparatus (not shown in the figure).

The second transmitting unit transmits the discovery request to Prose Func 108, which contains the above access restriction configuration information. Then, the fifth receiving unit receives, from Prose Func 108, the discovery response, which contains information obtained by applying a certain algorithm to the above access restriction configuration information. Thereafter, the first transmitting unit 701 is further used for the following: transmit, via the PC5 interface, information obtained by applying the algorithm to the access restriction configuration information to the remote UE101.

FIG. 8 is a block diagram illustrating an apparatus in a proximity service function for controlling access to the network by a remote UE via a relay UE. The apparatus 800 may be implemented as Prose Func 108 illustrated in FIG. 1, comprising: a third transmitting unit 801.

The working process of the apparatus 800 will be described below in detail with reference to FIGS. 1-5.

The third transmitting unit 801 is used to transmit, to the remote UE101, the access level configuration message, which contains the access level allocated to the remote UE. The access level configuration message and access level have been descried above in detail, which will not be repeated here.

In some embodiments, apparatus 800 further includes a fourth transmitting unit (not shown in the figure) used for, in response to the discovery request from the relay UE102, which contains the access restriction configuration information, transmitting, to the relay UE102, a discovery response, which contains the access restriction configuration information, the access restriction configuration information indicating remote UEs that cannot access the network via the relay UE102. The access restriction configuration information has been described above in detail, which will not be repeated here.

In some embodiments, to ensure security of data transfer, the discovery response further includes information obtained by applying a certain algorithm to the access restriction configuration information. The apparatus 800 further includes a fifth transmitting unit (not shown in the figure) for, in response to a discovery request from a remote UE101, which contains the access level of the remote UE101, transmitting a discovery response to the remote UE101, which contains information obtained by applying the algorithm to the access level.

Generally, the various exemplary embodiments of the present disclosure may be implemented in hardware or application-specific circuit, software, logic, or in any combination thereof. Some aspects may be implemented in hardware, while the other aspects may be implemented in firmware or software executed by a controller, a microprocessor, or other computing devices. When various aspects of the embodiments of the present disclosure are illustrated or described into block diagrams, flow charts, or other graphical representations, it would be understood that the block diagrams, apparatuses, systems, techniques or methods described here may be implemented, as non-restrictive examples, in hardware, software, firmware, dedicated circuit or logic, common software, or controller or other computing devices, or some combinations thereof.

As an example, the embodiments of the present disclosure can be described in a context of machine-executable instructions which are included, for instance, in the program module executed in the device on a target real or virtual processer. Generally, a program module includes routine, program, bank, object, class, component, and data structure, etc. and performs a particular task or implements a particular abstract data structure. In the embodiments, the functions of the program modules can be combined or divided among the described program modules. The machine executable instructions for the program module can be executed locally or in a distributed device. In the distributed device, the program module can be located between the local and remote storage mediums.

The computer program code for implementing the method of the present disclosure may be complied with one or more programming languages. These computer program codes may be provided to a general-purpose computer, a dedicated computer or a processor of other programmable data processing apparatuses, such that when the program codes are executed by the computer or other programmable data processing apparatuses, the functions/operations prescribed in the flow chart and/or block diagram are caused to be implemented. The program code may be executed completely on a computer, partially on a computer, partially on a computer as an independent software packet and partially on a remote computer, or completely on a remote computer or server.

In the context of the present disclosure, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium include, an electrical connection having one or more wires, a portable computer magnetic disk, hard drive, random-access memory (RAM), read-only memory (ROM), erasable programmable read-only memory (EPROM or flash memory), optical storage device, magnetic storage device, or any appropriate combination thereof.

Besides, although the operations are depicted in a particular sequence, it should not be understood that such operations are completed in a particular sequence as shown or in a successive sequence, or all shown operations are executed so as to achieve a desired result. In some cases, multi-task or parallel-processing would be advantageous. Likewise, although the above discussion includes some specific implementation details, they should not be explained as limiting the scope of any invention or claims, but should be explained as a description for a particular embodiment of a particular invention. In the present invention, some features described in the context of separate embodiments may also be integrated into a single implementation. On the contrary, various features described in the context of a single implementation may also be separately implemented in a plurality of implementations or in any suitable sub-group.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A method in a remote UE for controlling the remote UE to access a network via a relay UE, comprising:
receiving, from a proximity service function, an access level configuration message which contains an access level allocated to the remote UE;
receiving access restriction configuration information from the relay UE via a PC5 interface, the access restriction configuration information indicating remote UEs that are unable to access the network via the relay UE;
when an application on the remote UE initiates a request for accessing the network, rejecting the request for accessing the network if the access level of the remote UE is matched with the access restriction configuration information.

2. The method according to claim 1, wherein the method further comprises:
obtaining, from the proximity service function, information obtained by applying a certain algorithm to the access level;
wherein receiving the access restriction configuration information from the relay UE via the PC5 interface further comprises:
receiving, from the relay UE via the PC5 interface, information obtained by applying the algorithm to the access restriction configuration information;
wherein the matching step further comprises:
when the application on the remote UE initiates the request for accessing the network, rejecting the request for accessing the network if the information obtained by applying the algorithm to the access level of the remote UE is matched with the information obtained by applying the algorithm to the access restriction configuration information.

3. The method according to claim 1, wherein the method further comprises:
receiving, from the proximity service function, an access restriction cancelling message which contains access restriction cancelling information, the access restriction cancelling information indicating a condition for cancelling an access restriction;
when the condition for cancelling the access restriction is met, allowing the remote UE to access the network via the relay UE.

4. A method in a relay UE for controlling a remote UE to access a network via the relay UE, comprising:
receiving, from an eNB, a D2D access restriction configuration message which contains access restriction configuration information, the access restriction configuration information indicating remote UEs that are unable to access the network via the relay UE;
transmitting the access restriction configuration information to the remote UE via a PC 5 interface.

5. The method according to claim 4, wherein the method further comprises:
transmitting a discovery request to a proximity service function, the discovery request containing the access restriction configuration information;
receiving, from the proximity service function, a discovery response which contains information obtained by applying a certain algorithm to the access restriction configuration information;
wherein transmitting the access restriction configuration information to the remote UE via the PC5 interface further comprises:
transmitting, to the remote UE via the PC5 interface, the information obtained by applying the algorithm to the access restriction configuration information.

6. A method in a proximity service function for controlling a remote UE to access to a network via a relay UE, comprising:
transmitting, to the remote UE, an access level configuration message which contains an access level allocated to the remote UE.

7. The method according to claim 6, wherein the method further comprises:
in response to a discovery request from the relay UE, the discovery request containing access restriction configuration information, transmitting a discovery response to the relay UE, the discovery response containing the access restriction configuration information, the access restriction configuration information indicating remote UEs that are unable to access the network via the relay UE.

8. The method according to claim 7, wherein transmitting the discovery response to the relay UE further comprises: the discovery response containing information obtained by applying a certain algorithm to the access restriction configuration information;
the method further comprises:
in response to the discovery request from the remote UE, the discovery request containing an access level of the remote UE, transmitting, to the remote UE, the discovery response which contains information obtained by applying the algorithm to the access level.

9. An apparatus in a remote UE for controlling the remote UE to access to a network via a relay UE, comprising:
a first receiving unit configured to receive, from a proximity service function, an access level configuration message which contains an access level allocated to the remote UE;
a second receiving unit configured to receive access restriction configuration information from the relay UE via a PC5 interface, the access restriction configuration information indicating remote UEs that are unable to access the network via the relay UE;
a first access controlling unit configured to, when an application on the remote UE initiates a request for accessing the network, reject the request for accessing the network if the access level of the remote UE is matched with the access restriction configuration information.

10. The apparatus according to claim 9, wherein the apparatus further comprises:
an obtaining unit configured to obtain, from the proximity service function, information obtained by applying a certain algorithm to the access level;
wherein the second receiving unit is further configured to:
receive, from the relay UE via the PC5 interface, information obtained by applying the algorithm to the access restriction configuration information;
wherein the first access controlling unit is further configured for:
when the application on the remote UE initiates the request for accessing the network, reject the request for accessing the network if the information obtained by applying the algorithm to the access level of the remote UE is matched with information obtained by applying the algorithm to the access restriction configuration information.

11. The apparatus according to claim 9, wherein the apparatus further comprises:
a third receiving unit configured to receive, from the proximity service function, an access restriction cancelling message which contains access restriction cancelling information, the access restriction cancelling information indicating a condition for cancelling the access restriction;
a second access controlling unit configured to, when the condition for cancelling the restriction is met, allow the remote UE to access the network via the relay UE.

12. An apparatus in a relay UE for controlling a remote UE to access to a network via the relay UE, comprising:
a fourth receiving unit configured to receive, from an eNB, a D2D access restriction configuration message which contains access restriction configuration information, the access restriction configuration information indicating remote UEs that are unable to access the network via the relay UE;
a first transmitting unit configured to transmit the access restriction configuration information to the remote UE via a PC5 interface.

13. The apparatus according to claim 12, wherein the apparatus further comprises:
a second transmitting unit configured to transmit a discovery request to a proximity service function, the discovery request containing the access restriction configuration information;
a fifth receiving unit configured to receive, from the proximity service function, a discovery response which contains information obtained by applying a certain algorithm to the access restriction configuration information;
wherein the first transmitting unit is further configured to:
transmit, to the remote UE via the PC5 interface, the information obtained by applying the algorithm to the access restriction configuration information.

14. An apparatus in a proximity service function for controlling a remote UE to access to a network via a relay UE, comprising:
a third transmitting unit configured to transmit, to the remote UE, an access level configuration message which contains an access level allocated to the remote UE.

15. The apparatus according to claim 14, wherein the apparatus further comprises:
a fourth transmitting unit configured to, in response to a discovery request from the relay UE, the discovery request containing access restriction configuration information, transmit a discovery response to the relay UE, the discovery response containing the access restriction configuration information, the access restriction configuration information indicating remote UEs that are unable to access the network via the relay UE.

16. The apparatus according to claim 15, wherein the discovery response further contains information obtained by applying a certain algorithm to the access restriction information;
the apparatus further comprises:
a fifth transmitting unit configured to, in response to the discovery request from the remote UE, the discovery request containing the access level of the remote UE, transmit, to the remote UE, a discovery response which contains information obtained by applying the algorithm to the access level.
